(19) United States
(12) Patent Application Publication
(10) Pub. No.: US 2026/0149364 A1
(43) Pub. Date: May 28, 2026

(54) TRIANGULAR CURRENT MODE SWITCHED MODE POWER SUPPLY

(71) Applicant: STMICROELECTRONICS INTERNATIONAL N.V., Geneva (CH)

(72) Inventor: Jakub JIRSA, Brandys nad Orlici (CZ)

(21) Appl. No.: 19/388,555

(22) Filed: Nov. 13, 2025

(30) Foreign Application Priority Data
Nov. 27, 2024 (FR) 2413079

(51) Int. Cl. H02M 1/38; H02M 1/00; H02M 3/158

(52) U.S. Cl. CPC H02M 1/385; H02M 1/0009; H02M 1/0025; H02M 3/158

(57) ABSTRACT

The present disclosure provides for a switched mode power supply and a method for controlling the same. An example switched mode power supply includes an H bridge with two branches connected between a first output and a node coupled to a second output. An inductor is connected between a first input and a first of the two branches. The switched mode power supply operates in TCM. Each end of a discharging phase of the inductor is controlled by a circuit, based on a comparison of a threshold with a voltage between the second output and the node, the ground being applied on the node or the second output.

### CROSS REFERENCE TO RELATED APPLICATION(S)

This application claims the priority benefit of French Patent Application Number FR2413079, filed on Nov. 27, 2024, entitled “Triangular Current Mode Switched Mode Power Supply,” which is hereby incorporated by reference to the maximum extent allowable by law.

### TECHNICAL FIELD

The present disclosure relates generally to electronic circuits, for example integrated electronic circuits. The present disclosure relates more particularly to switched mode power supply (SMPS).

### BACKGROUND

There are various known SMPS. Among these known SMPS, SMPS having a H-bridge and an inductor connected between an input of the SMPS and an intermediate node of one of the two branches of the H-bridge are more particularly discussed here, in particular when these SMPS operates in triangular current mode (TCM). These SMPS are the to operate in TCM because of triangular shape of the current flowing into the inductor of the SMPS.

In such known SMPS operating in TCM, it is usual to implement a power factor correction function (PFC).

However, known SMPS operating in TCM with a PFC, or, the otherwise, TCM PFC SMPS, have drawbacks.

For example, the TCM PFC SMPS described in the article “Ultraflat Interleaved Triangular Current Mode (TCM) Single-Phase Rectifier” of C. Marxgut et al., published in IEEE Transaction On Power Electronics, vol. 29, N°2, pages 873-882 on February 2014 comprises a control logic located at the AC input of the SMPS to measure the current in the inductor, and thus needs an expensive galvanic isolation between this logic and the gate of the transistors of the H-bridge, and also needs an isolated amplifier for measuring the output voltage of the SMPS. These needs for galvanic isolation make the SMPS complex and cumbersome.

### BRIEF SUMMARY

There is a need for addressing all or some of the drawbacks of known SMPS operating in TCM, for example of known SMPS operating in TCM with a PFC function.

One embodiment addresses all or some of the drawbacks of known SMPS operating in TCM, for example of known SMPS operating in TCM with a PFC function.

One embodiment provides a switched mode power supply configured to receive an AC input voltage between first and second input terminals and to provide a DC output voltage between first and second output terminals, the switched mode power supply comprising:
a H bridge comprising:
   a first branch comprising a first switch connected between the first output terminal and a first node coupled to the first input terminal by an inductor, and a second switch connected between the first node and a second node coupled to the second output terminal, and
   a second branch comprising a third switch connected between the first output terminal and a third node connected to the second input terminal, and a fourth switch connected between the third node and the second node; and
a control circuit for controlling the switches to implement a triangular current mode comprising alternated charging and discharging phases of the inductor, the control circuit comprising a comparator circuit configured to provide a binary signal indicating a result of a comparison between:
   a threshold and a voltage on the second node when the second output terminal is configured to receive a reference potential, or
   the threshold and a voltage on the second output terminal when the second node is configured to receive the reference potential, wherein, at each discharging phase, the control circuit is configured to end the discharging phase in response to a switching of the binary signal.

Another embodiment provides a method for controlling a switched mode power supply receiving an AC input voltage between first and second input terminals and providing a DC output voltage between first and second output terminals, the switched mode power supply comprising a H bridge comprising:
a first branch comprising a first switch connected between the first output terminal and a first node coupled to the first input terminal by an inductor, and a second switch connected between the first node and a second node coupled to the second output terminal, and
a second branch comprising a third switch connected between the first output terminal and a third node connected to the second input terminal, and a fourth switch connected between the third node and the second node,
   the method comprising:
controlling the switches with a control circuit to implement a triangular current mode comprising alternated charging and discharging phases of the inductor;
providing, with a comparator circuit of the control circuit, a binary signal indicating a result of a comparison between:
a threshold and a voltage on the second node when the second output terminal receives a reference potential, or
the threshold and a voltage on the second output terminal when the second node receives the reference potential; and
at each discharging phase, ending the discharging phase with the control circuit in response to a switching of the binary signal.

According to one embodiment, the switched mode power supply comprises a shunt resistor connected between the second output terminal and the second node.

According to one embodiment, at each charging phase, a duration of the charging phase is calculate based on an inductance value of the inductor, a current value of the input voltage, a targeted minimal value of a current flowing though the inductor, and a targeted average value of the current.

According to one embodiment:
the second output terminal is configured to receive the reference potential;
the threshold is positive and determined by the targeted minimal value; and
at each discharging phase, the discharging phase ends when the binary signal indicates that the voltage of the second node becomes superior to the threshold.

According to one embodiment:
the second node is configured to receive the reference potential;
the threshold is negative and determined by the targeted minimal value; and
at each discharging phase, the discharging phase ends when the binary signal indicates that the voltage of the second output terminal becomes inferior to the threshold.

According to one embodiment: the second node is configured to receive the reference potential;
the threshold is positive; and
at each discharging phase, the discharging phase ends at the end of a delay starting when the binary signal indicates that the voltage of the second output terminal becomes inferior to the threshold, the delay being determined by the value of the input voltage, the inductance value of the inductor and a value of a voltage on the first output terminal.

According to one embodiment, the targeted average value is calculated in order to implement a power factor correction.

According to one embodiment, each end of a charging phase triggers a start of a discharging phase, the discharging phase starting at the end of the charging phase, or at the end of a dead time starting with the end of the charging phase.

According to one embodiment, if the input voltage is outside a range of values corresponding to a null value of the input voltage, each end of a discharging phase triggers a start of a charging phase, the charging phase starting at the end of the discharging phase, or at the end of a dead time starting with the end of the discharging phase.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 illustrates an example of a circuit of a SMPS adapted to operate in TCM;

FIG. 2 illustrates a waveform example of a current flowing in an inductor of the SMPS of FIG. 1 when operating in TCM;

FIG. 3 illustrates an example embodiment of a SMPS circuit configured to operate in TCM;

FIG. 4 illustrates a flowchart of an embodiment of a control method implemented in the SMPS of FIG. 3;

FIG. 5 illustrates with waveforms the control method of FIG. 4 implemented in the SMPS of FIG. 3;

FIG. 6 illustrates an example of a further embodiment of a SMPS circuit configured to operate in TCM; and

FIG. 7 illustrates with waveforms the control method of FIG. 4 when implemented in the SMPS of FIG. 6.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail. Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10% or 10°, and preferably within 5% or 5°.

FIG. 1 illustrates an example of a circuit of a SMPS circuit 1 adapted to operate in TCM.

The circuit 1 comprises two input terminals (or nodes) In1 and In2. The circuit 1 is configured to receive an AC input voltage Vin between its two inputs In1 and In2. Although not shown in FIG. 1, an electromagnetic interference (EMI) filter may be connected between the inputs In1 and In2. The EMI filter is, for example, a capacitor having an electrode connected to input In1 and another electrode connected to input In2.

The circuit 1 comprise a H-bridge 100.

A first branch of the bridge 100 (on the left on FIG. 1) comprises a MOS transistor T1 connected between an output terminal (or node) Out1 of the circuit 100 and a node 102 of the bridge 100. For example, a first conduction terminal of the transistor T1 is coupled, preferably connected, to the output Out1, and a second conduction terminal of the transistor T1 is coupled, preferably connected, to the node 102.

The node 102 is coupled to the input In1 by an inductor L of the circuit 100. For example, a first terminal of the inductor L is coupled, preferably connected, to node 102, a second terminal of the inductor L being coupled, preferably connected, to input In1.

The first branch of the bridge 100 further comprises a MOS transistor T2 connected between node 102 and a node 104 of the bridge 100. For example, a first conduction terminal of the transistor T2 is coupled, preferably connected, to the node 102, and a second conduction terminal of the transistor T2 is coupled, preferably connected, to the node 104.

The node 104 is coupled to an output terminal (or node) Out2 of the circuit 100.

A second branch of the bridge 100 (on the right on FIG. 1) comprises a MOS transistor T3 connected between the output Out1 and a node 106 of the bridge 100. For example, a first conduction terminal of the transistor T3 is coupled, preferably connected, to the output Out1, and a second conduction terminal of the transistor T3 is coupled, preferably connected, to the node 106.

The node 106 is coupled, preferably connected, to the input In2.

The second branch of the bridge 100 further comprises a MOS transistor T4 connected between nodes 106 and 104. For example, a first conduction terminal of the transistor T4 is coupled, preferably connected, to the node 106, and a second conduction terminal of the transistor T4 is coupled, preferably connected, to the node 104.

The circuit 100 is configured to provide a DC output voltage Vout between its outputs Out1 and Out2. The circuit 100 for example comprises an output capacitor C connected between terminals Out1 and Out2. For example, the capacitor C has a first terminal coupled, preferably connected, to output Out1, and a second terminal coupled, preferably connected, to output Out2.

The transistors T1, T2, T3 and T4 of the bridge 100 implement four corresponding switches of the bridge 100.

Although not shown on FIG. 1, the circuit 100 further comprises a control circuit for controlling the switches T1, T2, T3 and T4 of the bridge.

For example, the control circuit is configured to apply a respective control signal on the gate of each of the transistors T1, T2, T3 and T4. Although not shown on FIG. 1, a driver circuit may be provided for each transistor T1 to T4, in order to adapt the control signal provided by the control circuit before applying this control signal on the gate of the transistor.

The control circuit is configured to control the transistors T1 to T4 in order to implement a TCM. The TCM comprises alternated charging and discharging phases of the inductor L.

For example, when the voltage Vin has a first polarity, for example a positive polarity when the potential on input In1 is superior to the potential on input In2, the control circuit is configured to control the transistor T4 to the ON-state, and the transistor T3 to the OFF-state. Conversely, when the voltage Vin has a second polarity opposite to the first polarity, for example a negative polarity when the potential on input In1 is inferior to the potential on input In2, the control circuit is configured to control the transistor T3 to the ON-state, and the transistor T4 to the OFF-state. Thus, the transistors T3 and T4 of the second branch of the bridge are controlled based on the polarity of the input voltage Vin.

For example, for implementing a charging phase of the inductor L, the control circuit is configured to control a first one of the transistors T1 and T2 to the ON-state and the second one of the transistors T1 and T2 to the OFF-state. Conversely, for implementing a discharging phase of the inductor L following the charging of the inductor L, the control circuit is configured to control the second one of the transistors T1 and T2 to the ON-state and the first one of the transistors T1 and T2 to the OFF-state. For example, when the voltage Vin has a positive polarity, respectively a negative polarity, the first one of the transistors T1 and T2 is the transistor T2, respectively the transistor T1, and the second one of the transistors T1 and T2 is the transistor T1, respectively T2.

The duration of the charging phases and the duration of the discharging phases are adapted based on the value of the input voltage Vin, the output voltage Vout and a desired power to transfer from the input to the output of the converter 1, so that the average value of the current IL flowing through the inductor L has a sine shape following the sine shape of the AC input voltage Vin. The in other word, the durations of the charging phases and the durations of the discharging phases are adapted in order to implement a PFC function. The duration of the charging phases and the duration of the discharging phases are adapted by a circuit not shown on FIG. 1.

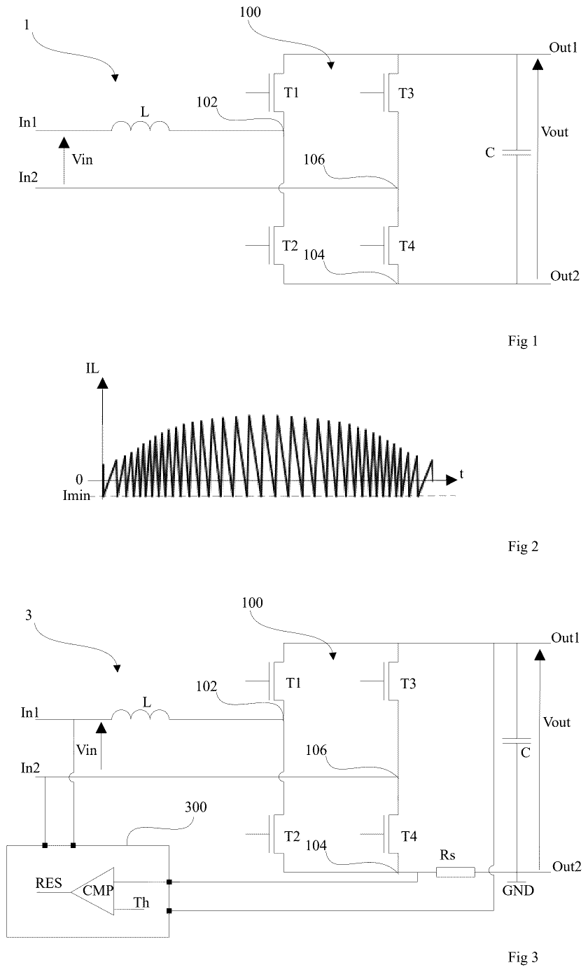

FIG. 2 illustrates a waveform example of the current IL of the SMPS of FIG. 1 when operating in TCM, with a PFC function.

In the example of FIG. 2, each charging phase of the inductor L corresponds to phase where the current IL increases from a minimal value Imin to a maximal current value of the charging phase, and each discharging phase of the inductor L corresponds to a phase where the current IL decrease from the maximal current value reached at the end of the previous charging phase, to the minimal value Imin. The value Imin is constant.

As previously indicated in relation with FIG. 1, by controlling the durations of the charging and discharging phases, the average value Iavg (not represented on FIG. 2) follows a sine shape.

For example, the duration Tch of each charging phase is calculated based on a known value Lv of the inductor L, a current absolute value of the voltage Vin, for example measured by the control circuit, a targeted minimal value Imin of the current IL, and a targeted average value Iavg of the current IL. For example, the targeted average value Iavg is determined or calculated based on the current absolute value of the voltage Vin and the current value of the voltage Vout.

For example, the duration Tch of each charging phase is calculated using the following equation:

$$T c h = \frac{2 \cdot Lv \cdot ( Iavg - I min )}{V i n} \qquad [ Math . 1 ]$$

with Lv the inductance value of the inductor L that is known, Imin the targeted minimal value of the current IL that is known, Vin the current absolute value of the input voltage that is measured, for example by the control circuit, and Iavg the targeted average value of the IL that is determined in order to implement a PFC function.

As the above equation [Math 1] is not valid when the current value of the input voltage Vin is null, the control of the transistor T1 to T4 for implementing TCM with PFC function is performed only when the input voltage Vin has a value that is not null. For example, when the voltage Vin is in a range of value, for example from −A to A, in which the voltage Vin is considered as being null, the control circuit does not trigger a new charging phase at the end of the previous discharging phase. For example, A is a positive value comprised in the range from 1 to 30 V, for example for an input voltage Vin having an amplitude comprised in the range from 80 to 260 V. As a complementary or alternative example, A can be determined based on the maximum value of Tch which can be set in the system.

For example, in FIG. 1, the control circuit ends each discharging phase when the current IL reaches the minimal value Imin. To do so, the control circuit needs to measure the current flowing through the inductor L. For example, a direct measure of the current IL implies to adds galvanic isolation in the circuit for controlling the transistors T1 to T4, whereas it is preferable to avoid using such complex galvanic isolation.

It is here proposed to determine, for each discharging phase, the end of the discharging phase by sensing an output current of the SMPS, that is a current flowing between terminal Out2 and node 104. More particularly, the end of each discharging phase is controlled based on a comparison of the sensed current with a threshold, the threshold being, according to one embodiment, at least in part determined by the targeted value Imin. According to one embodiment, a shunt resistor is added between the output Out2 and the node 104 for sensing the output current.

FIG. 3 illustrates an example embodiment of a SMPS circuit 3 configured to operate in TCM with a PFC function.

The circuit 3 comprises many elements in common with the circuit 1, and only the differences between these two circuits are here described in detail. Thus, unless specified otherwise, everything that has been described for the circuit 1 described in relation with FIG. 1 applies to the circuit 3 described in relation with FIG. 3.

The circuit 3 comprises a control circuit 300 for controlling the transistors T1 to T4 in order to implement TCM comprising alternated charging and discharging phases of the inductor L. Thus, unless this is not shown in FIG. 3, the circuit 300 provides four control signals to the respective transistors T1, T2, T3 and T4. For example, for each of the transistors T1, T2, T3 and T4, a corresponding driver circuit adapts the control signal provided by the circuit 300 before applying the control signal to the gate of the transistor.

The circuit 300 is further configured to sense the output current flowing between node 104 and output Out2, and to control the end of each discharging phase based on a comparison of the sensed current with a threshold.

The circuit 300 thus comprises a comparator circuit CMP configured to compare a voltage on the node 104 or a voltage on the output Out2 with a threshold Th. The threshold Th is at least in part determined by the targeted minimal value Imin. Preferably, the circuit CMP implements a hysteresis function when performing this comparison.

The circuit CMP provides a binary signal RES, that is a signal having two different states. The signal RES indicates whether the voltage that is compared with the threshold Th is superior or inferior to this threshold Th. Said in other words, the signal RES indicates the result of the comparison performed by the circuit CMP.

According to one embodiment, the circuit 3 comprises a shunt resistor Rs connected between the output Out2 and the node 104.

In the embodiment of FIG. 3, the output Out2 is configured to receive a reference potential, for example the ground GND of the output of the circuit 3. The voltage on node Out2 is thus null and constant, and the comparator CMP of circuit 300 compare the voltage of node 104, or the otherwise, the potential of node 104 referenced at the ground GND, to the threshold Th. Thus, the signal RES is in a first state when the voltage of node 104 is superior to the threshold Th, and in a second state when the voltage of node 104 is inferior to the threshold Th.

For example, the circuit 300 is referenced at the reference potential GND.

The circuit 300 is further configured, at each discharging phase, to end the discharging phase in response to a switching of the signal RES.

According to an embodiment, the output Out2 receives the reference potential GND as illustrated in FIG. 3. In such an embodiment, when the current IL flowing in the inductor L during a discharging phase decreases and becomes negative before reaching the minimal Imin value, the output current flowing from node 104 to output Out2 increases and becomes positive, and the voltage on node 104 thus increases and becomes positive. The threshold Th is then positive and may be entirely determined by the targeted minimal value Imin, for example, such that the current IL in the inductor L is at the minimal targeted value Imin when the voltage on node 104 becomes superior to the threshold during a discharging phase. In such an embodiment, at each discharging phase, the circuit 300, for example, ends the discharging phase in response to a switching of the signal RES indicating that the voltage on node 104 becomes superior to the threshold Th. Preferably, the circuit 300 controls the end the discharging phase as soon as the signal RES switches.

Advantageously, in the above embodiment, the comparator CMP can be supplied by a positive voltage referenced at the ground potential, the threshold Th is positive, and the voltage on the node 104 is positive when compared to the threshold Th, resulting in a simple implementation of the circuit CMP (no negative input(s) or supply).

As previously indicated in relation with the circuit 1, the control circuit 300 is, for example, configured to calculate the duration Tch of each charging phase based on the value Lv of the inductor L, the targeted minimal value Imin, the targeted average value Iavg, and the current value Vin of the input voltage, for example by using the equation [Math 1].

For example, the targeted average value Iavg is determined, or calculated, in order to implement a PFC function. Thus, the targeted average value Iavg follows a sine shape. For example, the targeted average value Iavg is determined or calculated based on the current absolute value of the voltage Vin and the current value of the voltage Vout. For example, the determination of the targeted average value Iavg is performed by a circuit of the circuit 3, for example a control-loop circuit, not shown on FIG. 3. For example, this circuit is a part of the circuit 300.

For example, the circuit 300 may receive the output voltage Vout. Thus, the circuit 300 may comprise an input connected to the output Out1.

For example, the circuit 300 may be configured to measure the current value Vin of the input voltage. Thus, the circuit 300 may comprise an input connected to the input In1, and a further input connected to the input In2 in order to receive the voltage Vin to be measured.

When the circuit 300 controls the transistors T1 to T4 to implement a TCM control (Vin is not considered as being null), the end of each charging phase triggers the next discharging phase. This next discharging phase may start at the end of the previous charging phase, or may start when at the end of dead time starting with the end of the previous charging phase.

When the circuit 300 controls the transistors T1 to T4 to implement a TCM control (Vin is not considered as being null), the end of each discharging phase triggers the next charging phase. This next charging phase may start at the end of previous discharging phase, or may start at the end of a dead time starting with the end of the previous discharging phase.

Although not shown on FIG. 3, the circuit 300 may comprises a timer circuit in order to set the duration Tech of the charging phases, the duration of a dead time between the end of a discharging phase and the start of the next charging phase when such a dead time is implemented, and the duration of a dead time between the end of a charging phase and the start of the next discharging phase when such a dead time is implemented.

For example, the timer circuit starts and when its output crosses a first threshold determined by a value of a dead time between the previous discharging phase and the start of a next charging phase, the circuit starts this charging phase. Then, when the output of the timer circuit crosses a second threshold determined by the duration Tech of the charging phase, the circuit 300 ends the charging phases. Then, when the output of the timer crosses a third threshold determined by a value of a dead time between the end of the charging phase and the start of the next discharging phase, the circuit 300 starts this discharging phase. At the ends of the discharging phase that is controlled by the circuit 300 in response to a switching of the signal RES, the timer circuit is, for example, reset.

Those skilled in the art will be able to adapt the above described example to a case where at least one of the two described dead time is null. More generally, those skilled in the art will be able to implement the circuit 300 otherwise than with a timer circuit to set the duration Tech of the charging phases, the duration of a dead time between the end of a discharging phase and the start of the next charging phase when such a dead time is implemented, and the duration of a dead time between the end of a charging phase and the start of the next discharging phase when such a dead time is implemented.

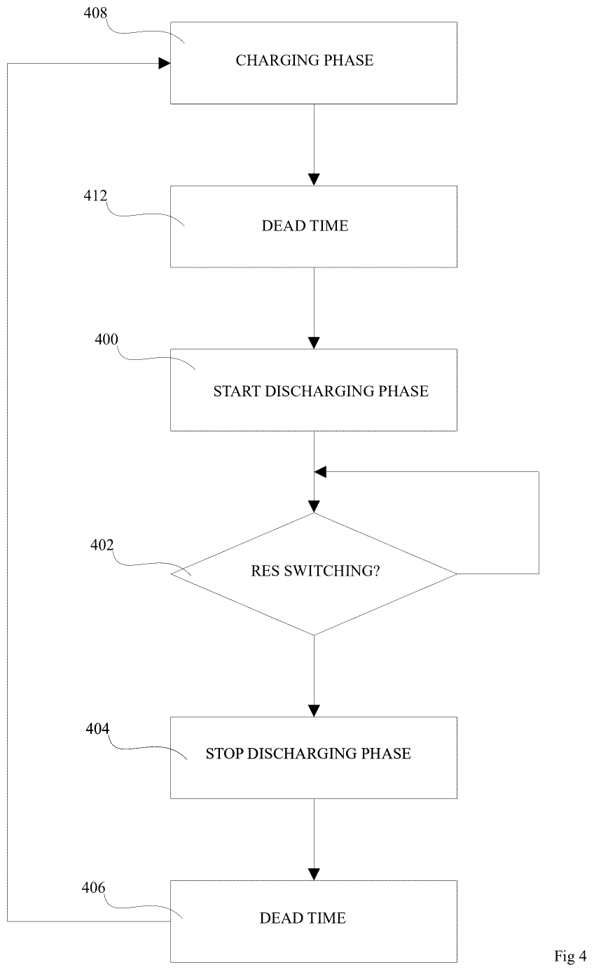

The FIG. 4 illustrates a flowchart of an embodiment of a control method implemented in the circuit 3 of FIG. 3.

At a step 400 (block “START DISCHARGING PHASE” in FIG. 4), the circuit 3, for example its control circuit 300, starts a discharging phase by controlling accordingly the ON and OFF states of the transistors T1 and T2.

At a next step 402 (block “RES SWITCHING?”), the circuit 300 check whether the RES signal switches. If this is not the case (output N of the block 402), the circuit 300 stays in step 402. If this is the case (output Y of the block 402), the control method continues with a step 404 (block “STOP DISCHARGING PHASE” in FIG. 4).

At the step 404, the circuit 300 controls the end of the current discharging phase, by controlling the transistors T1 and T2 accordingly, for example by controlling the OFF-state of the two transistors T1 and T2. For example, the circuit 300 controls the end of the discharging phase when entering step 404, with no delay.

At a next optional step 406 (block “DEAD TIME” in FIG. 4), the circuit 300 waits for the end of a dead time starting with the end of the previous discharging phase before the method continue to a step 408 (block “START CHARGING PHASE” in FIG. 4). For example, during the dead time of step 406, the circuit 300 controls the OFF-state of the two transistors T1 and T2.

In case the optional step 406 is not implemented, the step 404 is followed by step 408.

At the step 408, the circuit 300 implements a charging phase by controlling the ON and OFF states of the transistors T1 and T2 accordingly. The circuit 300 implements the charging phase so that it has a duration Tech calculated in order to implements a PFC function. When the charging phase ends, the control method continues with an optional step 410 (block “DEAD TIME” in FIG. 4).

At the step 410, the circuit 300 waits for the end of a dead time starting with the end of the previous charging phase before the method continue with the step 400. For example, during the dead time of step 410, the circuit 300 controls the OFF-state of the two transistors T1 and T2.

In case the optional step 410 is not implemented, the step 408 is followed by step 400.

Although not shown on FIG. 4, at the ends of the step 404, the implementation of the next step 406 or 408 could be conditioned by the fact that the input voltage Vin is not considered as being null.

FIG. 5 illustrates with waveforms a step of the control method of FIG. 4.

In FIG. 5, the method is implemented in the circuit 3 of FIG. 3, or, said in other words, in an embodiment of the circuit 3 where the output Out2 receives the reference potential GND.

Furthermore, in the example of FIG. 5, the steps 412 and 406 of the method of FIG. 4 are not implemented (no dead time). However, those skilled in the art will be able to adapt the example of FIG. 5 to others examples where the step 406 and/or the step 412 are implemented.

The FIG. 5 illustrates the evolution of current IL with a first waveform arranged on top of the FIG. 5. The FIG. 5 also illustrates the corresponding evolution of the voltage V104 on node 104 with a second waveform arranged in the middle of FIG. 5. The FIG. 5 also represents the different steps of method of FIG. 4 with blocks arranged on the bottom of FIG. 5.

At an initial time instant to, the circuit 300 starts a charging phase. During the charging phase (block 408), the current IL increases, and the voltage V104 is null.

At a next time instant t1 separated from the time instant to by the duration Tech of the charging phase, the circuit 300 ends the charging phase and starts a discharging phase (block 400). When the charging phase ends, the voltage V104 becomes negative.

From the time instant t1, after the discharging phase begins, the circuit 300 checks whether the signal RES switches (block 402). During this step 402, the current IL decreases and the voltage V104 increases until the voltage V104 reaches the threshold Th and becomes superior the threshold Th at a time instant t2.

At the time instant t2, the signal RES switches and this switching is detected by circuit 300. The threshold Th is determined by the targeted Imin value so that, when the the increasing voltage V104 crosses the threshold Th, the current IL is at the targeted value Imin. Thus, at the time instant t2, the step 402 ends and the circuit 300 ends the discharging phase at the step 404. When the discharging phases ends, the voltage V104 becomes null.

Then, the circuit 300 starts the next charging phase, and the operation of the circuit 3 described in relation with the time instants to, t1 and t2 is repeated in a cyclic manner.

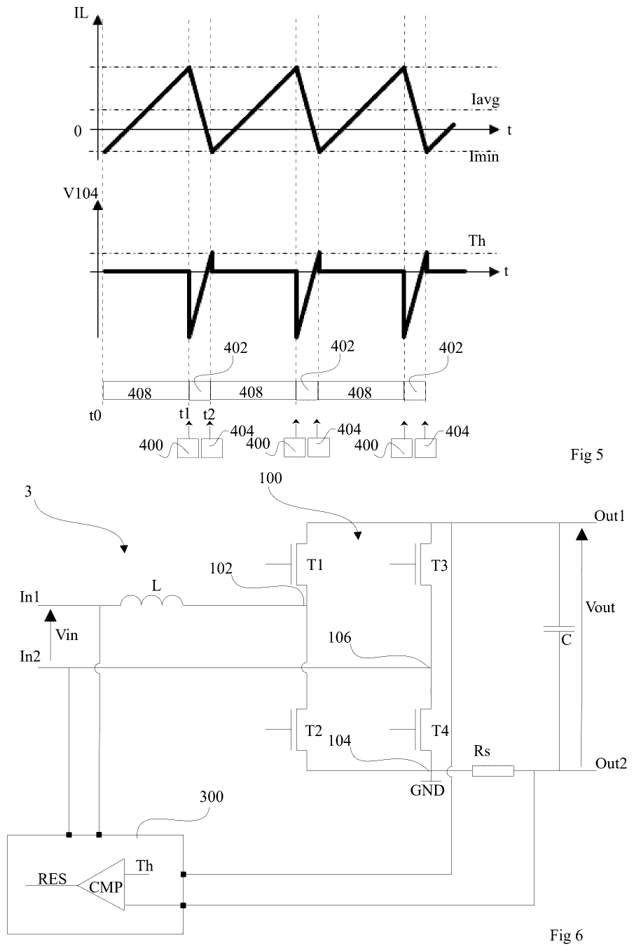

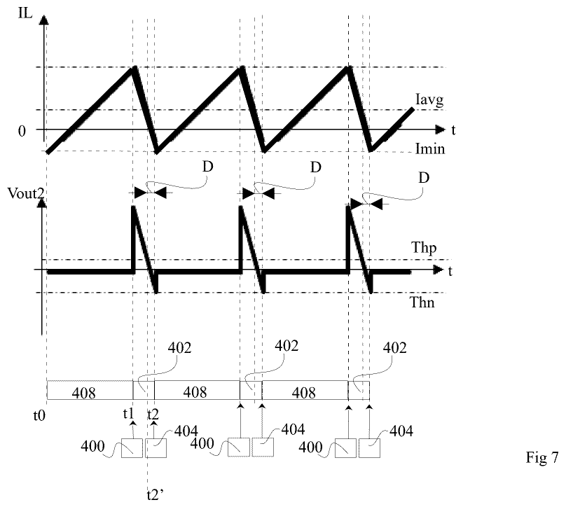

FIG. 6 illustrates an example of an alternative embodiment of the circuit 3 described in relation with FIG. 3.

The circuit 3 of FIG. 6 comprises many elements in common with the circuit 3 of FIG. 3, and only the differences between these two circuits are here described in detail. Thus, unless specified otherwise, everything that has been described for the circuit 3 described in relation with FIG. 3 applies to the circuit 3 described in relation with FIG. 6.

In the embodiment of FIG. 6, the node 104 receives the reference potential GND, whereas it was the output Out2 in the embodiment of FIG. 3.

Thus, in the embodiment of FIG. 6, the voltage on node 104 is thus null and constant, and the comparator CMP of circuit 300 compares the threshold Th with the voltage of output Out2, or the otherwise, with the potential of the output terminal Out2 referenced at the ground GND.

For example, the circuit 300 is referenced at the reference potential GND.

In the embodiment of FIG. 6, when the current IL flowing in the inductor during a discharging phase decreases and becomes negative before reaching the minimal Imin value, the output current flowing from output Out2 to node 104 increases and becomes negative, and the voltage on the output terminal Out2 thus decreases and becomes negative.

In relation with the above embodiment where the ground potential is applied on node 104, according to one embodiment, the threshold Th is negative and may be entirely determined by the targeted minimal value Imin, for example such that the current in the inductor is at the minimal targeted value Imin when the voltage on output Out2 becomes inferior to the threshold during a discharging phase. In such an embodiment, at each discharging phase, the circuit 300, for example, ends the discharging phase in response to a switching of the signal RES indicating that the voltage on node 104 becomes inferior to the threshold Th. Preferably, the circuit 300 controls the end the discharging phase as soon as the signal RES switches, or, the in other word, as soon as the circuit 300 enters the step 404. In the present embodiment, the comparator needs to compare with each other two negative voltages corresponding to the threshold Th and the voltage on the output Out2, which involves an implementation of the comparator CMP that is less simple than in the embodiment described in relation with FIG. 3.

Still in relation with the above embodiment where the ground potential GND is applied on node 104, according to another embodiment, the threshold Th is positive and is at least partly determined by the targeted minimal value Imin. In this embodiment, the current IL in the inductor L is not at the minimal targeted value Imin when the voltage on output Out2 becomes inferior to the threshold during a discharging phase. But, during each discharging phase, the slope of the decreasing voltage is calculated or estimated, for example by the circuit 300, based on the current value of the voltage Vout, the current value of the voltage Vin and the value Lv of the inductor L. Thus, the time period D between the moment when the voltage on the output Out2 is still positive and becomes inferior to the positive threshold, and the moment when the voltage on the output Out2 reaches a value corresponding to the moment when the current IL in the inductor L reaches the targeted minimal value Imin is calculated or estimated, for example by the circuit 300, based on the slope of the voltage on output Out2. In such an embodiment, at each discharging phase, the circuit 300, for example, ends the discharging phase at the end of a time period (or delay) D that starts with a switching of the signal RES indicating that the voltage on node 104 becomes inferior to the threshold Th. Said in other words, at each discharging phase, the discharging phase ends at the end of the delay D starting when the signal RES indicates that the voltage of output Out2 becomes inferior to the positive threshold Th, and the delay D is determined by the value of the input voltage Vin, the inductance value Lv of the inductor L and the value of the voltage on the output Out1. The in further other words, when the circuit enters the step 404 of the method of FIG. 4, the delay D elapses before the circuit 300 controls the end of the discharging phase. Such an embodiment allows for the use of a comparator CMP that compares two positive voltages corresponding to the voltage on the output Out2 and the threshold Th.

FIG. 7 illustrates with waveforms the control method of FIG. 4 when implemented in the circuit 3 of FIG. 6.

In FIG. 7, the method is implemented in the circuit 3 of FIG. 6, or, said in other words, in an embodiment of the circuit 6 where the node 104 receives the reference potential GND.

Furthermore, in the example of FIG. 7, the steps 412 and 406 of the method of FIG. 4 are not implemented. However, those skilled in the art will be able to adapt the example of FIG. 7 to others examples where the step 406 and/or the step 412 are implemented.

The FIG. 7 illustrates the evolution of current IL with a first waveform arranged on top of the FIG. 7. The FIG. 7 also illustrates the corresponding evolution of the voltage Vout2 on output Out2 with a second waveform arranged in the middle of FIG. 7. The FIG. 7 also represents the different steps of method of FIG. 4 with blocks arranged on the bottom of FIG. 7.

At an initial time instant to, the circuit 300 starts a charging phase. During the charging phase (block 408), the current IL increases, and the voltage Vout2 is null.

At a next time instant t1 separated from the time instant to by the duration Tech of the charging phase, the circuit 300 ends the charging phase and starts a discharging phase (block 400).

When the charging phase ends, the voltage Vout2 becomes positive.

From the time instant t1, after the discharging phase begins, the circuit 300 checks whether the signal RES switches (block 402). During this step 402, the current IL decreases and the voltage Vout2 decreases until the voltage Vout2 reaches the threshold Th and becomes inferior to the threshold Th at a time instant t2′ in an embodiment where the threshold Th is positive and referenced Thp on FIG. 7, or at a time instant t2 in another embodiment where the threshold Th is negative and referenced Thn.

In case of the negative threshold Thn, the threshold Thn is determined by the targeted Imin value so that, when the decreasing voltage Vout2 crosses the threshold Thn, the current IL is at the targeted value Imin. Thus, at the time instant t2, the step 402 ends and the circuit 300 ends the discharging phase (block 404) as illustrated on FIG. 7. When the discharging phases ends, the voltage Vout2 becomes null.

In case of the positive threshold Thp, based on the slope of the decreasing voltage Vout2, the circuit 300 calculates the delay D between the time instant when the decreasing voltage Vout2 becomes lower than the threshold Thp, and the time instant when the voltage Vout2 will reach a value corresponding to the moment when the current IL reaches the value Imin. Thus, when the signal RES switches at the time instant t2′ to indicates that the decreasing voltage Vout2 becomes lower than the threshold Thp, the circuit 300 enters the step 404 of the method of Figure and waits for the end of the calculated delay D before controlling the end the discharging phase at the time instant t2. When the discharging phases ends, the voltage Vout2 becomes null.

Then, the circuit 300 starts the next charging phase, at the instant t2 in the example of FIG. 7, and the operation of the circuit 3 described in relation with the instants to, t1, t2′ and t2 is repeated in a cyclic manner.

Various embodiments and variants of the circuit 3 have been described. Although not illustrated by specific Figures, the circuit 3 may be used in various technical fields where a power conversion between an AC voltage and a DC voltage is required. As an example, the circuit 3 may be used in charging devices for charging personal electronic devices such as a laptop or a mobile phone. As another example, the circuit 3 may be used in the field of the green energies, for example for converting an AC voltage in a DC voltage, for example when this AC voltage is provided by a device which converts a source of green energy into this AC voltage. As a further example, the circuit 3 may be used for providing a DC supply voltage to a LED device from an AC voltage, for example from the main. As a further example, the circuit 3 may be used in the front end for motor inverters in pumps of fans. More generally, the circuit 3 may be used when high efficiency conversion and compact size is required.

Various embodiments and variants have been described. Those skilled in the art will understand that certain features of these embodiments can be combined and other variants will readily occur to those skilled in the art.

In particular, in the previous description, the circuit 3 comprises MOS transistors T1, T2, T3 and T4. However, at least some of the MOS transistors T1, T2, T3 and T4 may be replaced by GaN HEMT transistors. More generally, the present description applies when the transistors T1, T2, T3 and T4 are replaced by corresponding switches T1, T2, T3 and T4.

Furthermore, in the above description, it is indicated that Iavg is determined in order to implement a PFC function. However, the above description also applies when Iavg determined otherwise than for implementing a PFC function, for example when Iavg as a constant value whatever is the current value of the voltage Vin.

Finally, the practical implementation of the embodiments and variants described herein is within the capabilities of those skilled in the art based on the functional description provided hereinabove. In particular, those skilled in the art will be capable of implementing the circuit 300 based on the functional description made of this circuit 300, and, further, those skilled in the art will be capable of implementing the circuit 300 otherwise than with a timer circuit.

1. A switched mode power supply configured to receive an AC input voltage between a first input terminal and a second input terminal and to provide a DC output voltage between a first output terminal and a second output terminal, the switched mode power supply comprising:
a H bridge comprising:
a first branch comprising a first switch connected between the first output terminal and a first node coupled to the first input terminal by an inductor, and a second switch connected between the first node and a second node coupled to the second output terminal;
a second branch comprising a third switch connected between the first output terminal and a third node connected to the second input terminal, and a fourth switch connected between the third node and the second node; and
a control circuit for controlling the first switch, the second switch, the third switch, and the fourth switch to implement a triangular current mode comprising alternated charging phases and discharging phases of the inductor, the control circuit comprising a comparator circuit configured to provide a binary signal indicating a result of a comparison between:
a threshold and a voltage on the second node when the second output terminal is configured to receive a reference potential; or
the threshold and a voltage on the second output terminal when the second node is configured to receive the reference potential; and
wherein, at each discharging phase, the control circuit is configured to end the discharging phase in response to a switching of the binary signal.

2. The switched mode power supply of claim 1, wherein the switched mode power supply comprises a shunt resistor connected between the second output terminal and the second node.

3. The switched mode power supply of claim 1, wherein, at each charging phase, a duration of the charging phase is calculate based on an inductance value of the inductor, a current value of the AC input voltage, a targeted minimal value of a current flowing though the inductor, and a targeted average value of the current.

4. The switched mode power supply of claim 3, wherein the second output terminal is configured to receive the reference potential;
herein the threshold is positive and determined by the targeted minimal value; and
wherein at each discharging phase, the discharging phase ends when the binary signal indicates that the voltage of the second node becomes superior to the threshold.

5. The switched mode power supply of claim 3, wherein the second node is configured to receive the reference potential;
wherein the threshold is negative and determined by the targeted minimal value; and
wherein at each discharging phase, the discharging phase ends when the binary signal indicates that the voltage of the second output terminal becomes inferior to the threshold.

6. The switched mode power supply of claim 3, wherein the second node is configured to receive the reference potential; the threshold is positive; and
wherein at each discharging phase, the discharging phase ends at an end of a delay starting when the binary signal indicates that the voltage of the second output terminal becomes inferior to the threshold, the delay being determined by a value of the AC input voltage, the inductance value of the inductor and a value of a voltage on the first output terminal.

7. The switched mode power supply of claim 3, wherein the targeted average value is calculated in order to implement a power factor correction.

8. The switched mode power supply of claim 1, wherein each end of a charging phase triggers a start of a discharging phase, the discharging phase starting at an end of the charging phase, or at an end of a dead time starting with the end of the charging phase.

9. The switched mode power supply of claim 1, wherein, if the AC input voltage is outside a range of values corresponding to a null value of the AC input voltage, each end of a discharging phase triggers a start of a charging phase, the charging phase starting at an end of the discharging phase, or at an end of a dead time starting with an end of the discharging phase.

10. A method for controlling a switched mode power supply receiving an AC input voltage between first input terminal and second input terminal and providing a DC output voltage between first output terminal and a second output terminal, the switched mode power supply comprising:
a H bridge comprising:
a first branch comprising a first switch connected between the first output terminal and a first node coupled to the first input terminal by an inductor, and a second switch connected between the first node and a second node coupled to the second output terminal;
a second branch comprising a third switch connected between the first output terminal and a third node connected to the second input terminal, and a fourth switch connected between the third node and the second node;
the method comprising:
controlling the first switch, the second switch, the third switch, and the fourth switch with a control circuit to implement a triangular current mode comprising alternated charging and discharging phases of the inductor;
providing, with a comparator circuit of the control circuit, a binary signal indicating a result of a comparison between:
a threshold and a voltage on the second node when the second output receives terminal a reference potential, or
the threshold and a voltage on the second output terminal when the second node receives the reference potential; and
at each discharging phase, ending the discharging phase with the control circuit in response to a switching of the binary signal.

11. The method of claim 10, wherein the switched mode power supply comprises a shunt resistor connected between the second output terminal and the second node.

12. The method of claim 10, wherein, at each charging phase, a duration of the charging phase is calculate based on an inductance value of the inductor, a current value of the AC input voltage, a targeted minimal value of a current flowing though the inductor, and a targeted average value of the current.

13. The method of claim 12, wherein the second output terminal is configured to receive the reference potential;
wherein the threshold is positive and determined by the targeted minimal value; and
wherein at each discharging phase, the discharging phase ends when the binary signal indicates that the voltage of the second node becomes superior to the threshold.

14. The method of claim 12, wherein the second node is configured to receive the reference potential;
wherein the threshold is negative and determined by the targeted minimal value; and
wherein at each discharging phase, the discharging phase ends when the binary signal indicates that the voltage of the second output terminal becomes inferior to the threshold.

15. The method of claim 12, wherein the second node is configured to receive the reference potential;
wherein the threshold is positive; and
wherein at each discharging phase, the discharging phase ends at an end of a delay starting when the binary signal indicates that the voltage of the second output terminal becomes inferior to the threshold, the delay being determined by a value of the AC input voltage, the inductance value of the inductor and a value of a voltage on the first output terminal.

16. The method of claim 12, wherein the targeted average value is calculated in order to implement a power factor correction.

17. The method of claim 10, wherein each end of a charging phase triggers a start of a discharging phase, the discharging phase starting at an end of the charging phase, or at an end of a dead time starting with the end of the charging phase.

18. The method of claim 10, wherein, if the AC input voltage is outside a range of values corresponding to a null value of the AC input voltage, each end of a discharging phase triggers a start of a charging phase, the charging phase starting at an end of the discharging phase, or at an end of a dead time starting with the end of the discharging phase.
